(19) United States
(12) Patent Application Publication
(10) Pub. No.: US 2011/0193342 A1
(43) Pub. Date: Aug. 11, 2011

(54) HOSE COUPLING

(75) Inventor: Tilman Hoefelmayr, Niederteufen (CH)

(73) Assignee: LACTOCORDER AG, Niederteufen (CH)

(21) Appl. No.: 12/737,977

(22) PCT Filed: Aug. 28, 2009
(86) PCT No.: PCT/EP2009/006260

§ 371 Date: Apr. 19, 2011

(30) Foreign Application Priority Data
Sep. 5, 2008 (DE) 10 2008 046 098.2

(51) Int. Cl. F16L 19/00

(52) U.S. Cl. 285/377

(57) ABSTRACT

The invention discloses a hose coupling (100) which, on the basis of design measures, can be provided with a small number of individual components (100a, 100b, 100c) so that high reliability during operation and simple handling during coupling and decoupling are achieved. The hose coupling can in particular be locked by rotation within a small angular range, without any movable components being necessary. In some illustrative embodiments, the hose coupling (100) is used as a coupling in fluid conduits in the agricultural sector, for example in milk lines.

The present invention generally relates to a hose coupling for establishing a connection with at least one hose piece so as to establish therewith a fluid connection for liquids and/or gases.

In many fields of everyday life and in many technical surroundings fluid connections on the basis of flexible connection conduits must often be established, and this often necessitates that the fluid conduit is separated at one or more points thereof. For example, a connection hose has to be connected to an outlet only temporarily, or access to suitable locations is necessary, e.g. for reasons of measurement, cleaning, etc., in the case of more or less permanently existing fluid connections. In order to facilitate a connection of two hose pieces or the coupling of a hose piece to a rigid connection, hose couplings suitable for such use are provided, said hose couplings being used for allowing the fluid connection to be established and separated quickly. To this end, a large number of hose couplings is available on the market, said hose couplings being adapted to the respective conditions of use to a greater or lesser extent.

There are, however, also numerous cases of use in which the presently available hose couplings do not represent a suitable solution. For example, especially in the field of the food industry, the fluid connections in question must fulfil special requirements which make the use of the presently available hose couplings appear unsuitable in cases where a quick and efficient separation of a fluid connection is desired or required. Fluid connections in the food industry must e.g. be chemically inert with respect to the substances to be conveyed and, in addition, they must also be chemically resistant to respective cleaning chemicals that have to be used at regular intervals so as to satisfy the hygienic requirements which are in some cases very strict. In addition, it may also be necessary to consider relevant temperature ranges, which exclude the use of many of the presently available hose couplings. A particularly demanding case of use is, in the field of food industry, agriculture, and especially the field of dairy farming.

In milk producing agricultural enterprises many animals, e.g. dairy cows, are kept under strictly controlled conditions, and especially the milking process is executed with the aid of automated or semi-automated milking plants. In the case of a fully automated or semi-automated milking process, a milking unit is normally attached to the teats of the dairy animals, a process which may be carried out by means of fully automated devices or through the personnel in question. Already in this phase of the milking process, it is necessary to observe precise hygiene regulations, whose violation may lead to an impaired quality of the milk and, in the long rung, also to a reduction of yield in view of a possible impairment of the animals' health. When the milking unit has been applied and when a suitable stimulation phase has been carried out, milk is sucked from the teats, a process which typically takes place under generation of a suitable “operating vacuum”, which is applied to the teat and which allows, at least temporarily, an extraction of milk by suction, so that in this phase milk is sucked from the teat via the milking cup and, finally, into a milk line; the operating vacuum must be applied to all these components. Depending on the milking strategy used, milk is sucked from the individual teats in a continuous or pulsed sequence, in which a suction phase is followed by a respective relief or massage phase caused by a collapse of the teat rubber. It follows that, during the milking process, milk is sucked from the animal's teat in a continuous or pulsed sequence, the milk being then sucked into the milk line and subsequently into a reservoir, flexible connection hoses, e.g. in the form of the hose connections leading away from the milking unit to a respective rigid fluid connection, being used along a distinct area of the whole fluid conduit. In view of the fact that the respective flexible connection conduits are used in the surroundings of more or less automated stables and milking palours, there will be demanding hygienic boundary conditions and also high loads with respect to deformations and tread loads acting on the fluid connections. This is the reason for the fact that the materials used in particular for the milk hoses leading away from a respective claw piece or a milking unit often have, on the one hand, the necessary compatibility with the milk and the cleaning liquids in question and, on the other hand, also a high mechanical loadability, so that these milk hoses normally have a limited elasticity and necessitate therefore a comparatively high expenditure of energy for attaching them to or detaching them from a junction.

Under these demanding conditions, a separation of the milk line may perhaps entail, with respect to hygienic aspects, a certain risk of an undesirable additional contamination and also an impairment of the flow characteristics of the milk, since the provision of coupling parts in the fluid conduit may cause additional turbulences which, in turn, affect the quality of the milk. On the other hand, additional irregularities in the surface of a fluid conduit may lead to a formation of residues after the use of the fluid conduit, which, in turn, may result in higher hygienic loads during a future use of the fluid conduit due to the influence of bacteria and the like on the milk residues,

A frequent temporary separation of milk lines is, however, extremely desirable with respect to the general monitoring and control of the sequence of operations in an agricultural enterprise, since this is the only possibility of obtaining quantitative and also qualitative information on the general flow of milk in an agricultural enterprise and, consequently, also on the economic efficiency and the animals' health. For example, many agricultural enterprises regularly carry out a measurement of the amount of milk in the milk line. To this end, a suitable milk meter has to be introduced in the milk line. The milk meter is typically provided with respective connecting pieces which are to be connected to the hose pieces of the milk line. In view of the above-mentioned mechanical properties of the milk lines, the process of coupling and decoupling the milk lines is an operation which necessitate much time and a great expenditure of energy and which, especially in large agricultural enterprises, leads to a substantial impairment of the total efficiency in view of the operating personnel resources required. In addition, also the fact that the exterior of the milk hoses shows a high degree of contamination and/or wear in view of the surrounding conditions, which are sometimes very demanding, results in a further disadvantageous effect of fluid conduit separation, so that it is not only the expenditure of time and energy but also the resultant contamination of the operating personnel which are considered disadvantageous.

With respect to the above-described situation, it is the object of the present invention to provide a hose coupling in which design measures are taken into account so as to eliminate or reduce at least some of the above-mentioned drawbacks, in particular when the field of food-conveying fluid connections is considered.

According to one aspect of the present invention, this object is achieved by a hose coupling comprising a first coupling part and a second coupling part. In addition, a locking device is provided, which comprises a first engagement area on the first coupling part and a second engagement area complementary with said first engagement area, said first and second engagement areas being adapted to be locked by rotation, without any movable components being used.

It follows that, making use of design measures, the hose coupling according to the present invention is designed such that simple and reliable locking and, consequently, a connection of all the coupling parts can be accomplished. In particular the avoidance of movable components guarantees a desirable simple overall design, which offers a significant advantage with respect to use and also with respect to hygienic requirements that may have to be satisfied. The fact that the two engagement areas are locked by rotation, such locking being accomplished in illustrative embodiments under a small angle of less than 90°, additionally allows handling under avoidance of a high expenditure of energy, since even comparatively rigid hose lines, of the type used e.g. in the form of milk lines, can be rotated within this comparatively small angular range, so that, although locking with a comparatively low expenditure of energy is possible, the inherent elasticity of the flexible hose will contribute to stable locking during operation. It follows that separation and locking can be accomplished by taking hold of a respective hose end, each with one hand, without the necessity of operating any additional locking mechanisms, e.g. in the form of coupling nuts, levers, etc.

According to a further advantageous embodiment, the first engagement area of the locking device comprises at least one cam, and the second engagement area comprises a locking recess which is complementary to said at least one cam. This kind of structural design of the engagement areas guarantees that, on the one hand, reliable locking through the rotary movement will be guaranteed, whereas, on the other hand, a simple overall structural design can be accomplished, so that a high mechanical reliability is achieved in addition to a good manageability, since structurally simple but stable components are used for the locking device.

According to another embodiment, the first engagement area comprises at least two cams, and the second engagement area comprises locking recesses which are complementary to said at least two cams. It is thus possible to accomplish an even more stable coupling of the two coupling parts, with the cams and the complementary recesses being adapted to be provided at suitable positions. The cams can e.g. be arranged such that they are displaced relative to one another by 180°, or such that, in addition to an angular displacement, they are also arranged in axially spaced relationship with one another, so that a desired high mechanical stability is guaranteed.

In accordance with a further embodiment, the first engagement area of the locking device comprises precisely four cams, and the second engagement area comprises locking recesses which are complementary to said four cams. Due to this design measure, a high degree of production reliability is accomplished on the basis of an only moderate expenditure, since the four cams guaranteeing the locked condition and the respective recesses can be provided over a large area of the circumference of the coupling parts. The four cams may, for example, be provided along the circumference at relatively identical angular distances from one another, so that a very symmetrical distribution of the respective forces guaranteeing the locking will be obtained. In the case of further embodiments, at least some of the four cams may be axially spaced from one another, when an even higher “rigidity” of the hose coupling is desired, if transverse loads should occur.

According to another advantageous embodiment, a sealing is provided in the first and/or in the second coupling part. The provision of the sealing allows a very reliable fluid connection to be established. In particular, also a high degree of tightness is given, if gas/liquid mixtures should be dealt with, or if a “vacuum”, i.e. a negative pressure that may be as high as a few pascals, should exist. This will be especially advantageous for cases of use in dairy farming. The sealing is to be regarded as a “non movable” component, which does not undergo any change of position, not even with respect to parts of the sealing, with the exception of a minor dimensional change occurring when the first and second coupling parts are being locked.

The term “movable component” in the sense used in the present context is to be interpreted such that no change of position of the component in its entirety or of subareas thereof takes place, with the exception of a certain minimum deformation caused by the inherent elasticity, as is e.g. the case with elastic sealing materials. On the other hand, a spring, which undergoes deformation, and in the case of which e.g. an end portion undergoes a change of position, is interpreted as a movable component within the meaning of the present application.

According to one embodiment, the sealing is provided in the form of an O-ring. A well-proven and reliable mode of sealing is obtained in this way, the O-ring being here arranged at a defined position, which is also maintained during locking, with the exception of a minor deformation of the sealing material, as has also been specified hereinbefore. It follows that a reliable sealing of the hose coupling can be accomplished by means of easily available and well-proven components. Due to the stable position, even the inherent elasticity of the O-ring may contribute as a resetting force to the maintenance of the locked position.

In accordance with another preferred embodiment, the O-ring is provided on the first coupling part. By means of this measure, it is accomplished that the O-ring is, together with the respective cam, applied to the first coupling part, so that the sealing ring will easily be accessible in the separated condition of the fluid connection.

According to a further advantageous embodiment, the first and the second coupling part are each provided with a hose connection area, which is implemented as a thin tube and which has a wall thickness of 3 mm or less. It follows that, making use of a thin tube at the end piece, also hose pieces having a comparatively low inherent elasticity can be connected to the first and/or second coupling part. The desired internal diameter of the hose piece can essentially be maintained also across the hose coupling, so that the flow characteristics will not be impaired with respect to flow rate and/or pressure. In addition, by means of suitable bevelling of the ends of the hose connection areas also the respective front end face can be kept small, so that the boundary current in the area of the hose connection, i.e. in the area of transition between the hose and the coupling part, will only be influenced to a negligible extent.

According to another advantageous embodiment, the first and the second coupling part are each provided with a transition area, said transition areas defining together a fluid path when the first and the second coupling part are locked, said fluid path defining a surface which does not cause major turbulences. These design measures are taken for keeping, in the area of the hose coupling, the influence of the hose coupling on the fluid flow small, so that in critical fields of use, e.g. when a flow of milk is being conveyed, the impairment of quality will almost be negligible.

According to another embodiment, the transition areas defining the fluid path have neither any elevations on nor any depressions in their surfaces. This is accomplished by making only the respective end faces of the first and of the second coupling part join one another, so that, with the exception of the respective joint, a continuous surface causing no interference is formed.

In accordance with another advantageous embodiment, the hose coupling is configured for connection to or coupling to food-conveying hose pieces, i.e. the materials used are compatible with the demands that have to be fulfilled for the food to be conveyed, in particular one embodiment of the hose coupling being adapted to convey milk. In cooperation with the overall structural design, a very efficient coupling is obtained in this way, since, on the one hand, the hygienic demands can effectively be fulfilled because the respective components of the hose coupling come into contact with both the relevant cleaning liquids and the food to be conveyed, and since, on the other hand, also reliability and tightness are accomplished with respect to vacuum guidance. In addition, the structurally simple design, i.e. the avoidance of movable components, provides efficient easy handling, a permanent reliable connection being nevertheless accomplished even if the coupling should be frequently operated. As has been described at the beginning, it is thus possible to carry out, especially in the field of agricultural farming, respective separations of the milk lines with little expenditure of time and little contamination of the operating personnel, so as to allow components, such as measurement devices and the like, to be attached by means of coupling.

According to an illustrative embodiment, the first and the second coupling part comprises polyamide material, and, according to further embodiments, polyamide material is provided in the form of polyamide 6 and/or polyamide 12. The materials mentioned have the desired mechanical and chemical properties allowing their use in particular in the food sector and in particular in the field of agricultural farming. A comparatively low percentage of water in the polyamide 6 material already contributes to excellent properties as regards mechanical and chemical properties. If the material polyamide 12 is used, the water content will even be lower than that, whereby an even more reduced interaction with the fluid to be conveyed and with other substances, e.g. cleaning substances and the like, may possibly be achieved.

In accordance with a further advantageous embodiment, the first and the second coupling part are, with the exception of the sealing, fully produced from a uniform material. This will lead to a simple overall structural design, and also the manufacturing process can be carried out efficiently and with high precision, e.g. be injection moulding. In particular, the concrete formation of the locking device is advantageously predetermined by design measures, i.e. by the respective injection mould, with a high degree of precision, so that only small component tolerances will occur. This, however, will also contribute to a high reliability and a good manageability.

According to another aspect of the present invention, the above-mentioned object is achieved by a hose coupling for connection to a hose piece that is suitable for conveying food. The hose coupling comprises a first coupling part, a second coupling part and a sealing ring attached to said first or said second coupling part. In addition, said first coupling part and said second coupling part comprise areas which are configured such that they are complementary to one another and which do not include any movable components, and said first and second coupling parts are adapted to be locked on one another by means of said complementary areas.

Also according to this aspect of the present invention, the hose coupling for use with food-conveying hose pieces is, by means of design measures, configured such that easy manageability and a high degree of reliability in combination with the desired mode of operation, e.g. with respect to hygienic requirements, a substantially interference-free flow, vacuum tightness and the like are accomplished.

According to an advantageous embodiment, the complementary areas are dimensionally stable when they are being locked. Locking is thus achieved without any deformation of component areas so that, on the whole, a higher degree of reliability will be accomplished, since a possible fatigue of material, which may be caused e.g. by spring locks, etc., will substantially be avoided.

Also according to this aspect, suitable cams and recesses can be provided, which allow reliable locking of the two coupling parts.

In accordance with a further advantageous embodiment, the first coupling part, the second coupling part and the sealing ring are the only components of the hose coupling. This property achieves to a specially high degree not only efficient manufacturing but also the desired behaviour during operation and cleaning, i.e. since only these three components are required, very time-efficient handling as well as a high degree of reliability are given, since failure of the individual components during operation will hardly occur and since the only component which may perhaps have to be replaced is the sealing ring after a prolonged period of use. In addition, also efficient cleaning of the hose coupling is possible in view of the small number of individual components.

In the following, additional illustrative embodiments will be described in more detail. In so doing, reference is also made to the accompanying drawings, in which:

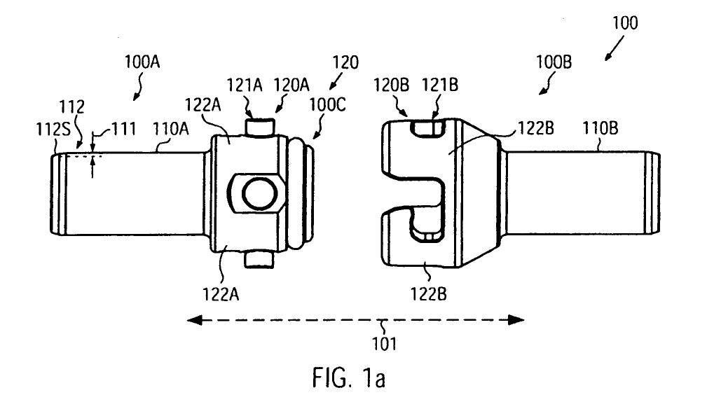

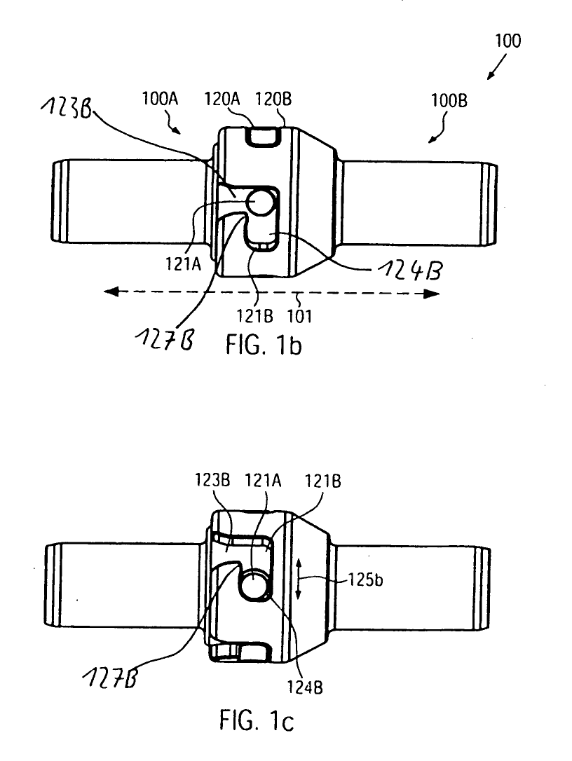

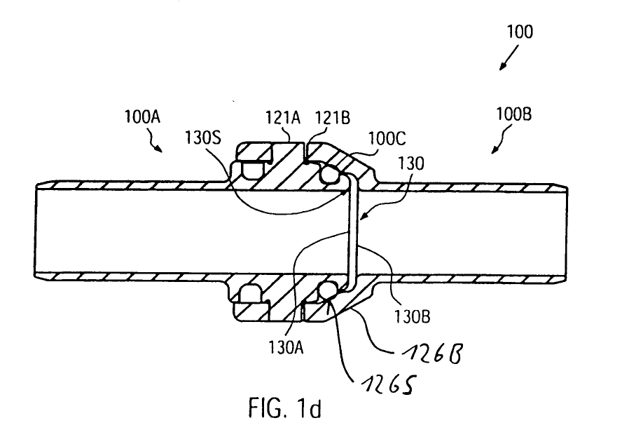

FIG. 1a schematically shows a side view of a hose coupling with two coupling parts according to illustrative embodiments;

FIG. 1b schematically shows the hose coupling in a joined condition prior to locking;

FIG. 1c schematically shows the hose coupling in a locked condition; and

FIG. 1d schematically shows a cross-sectional view of the hose coupling in the joined condition according to illustrative embodiments

FIG. 1a shows schematically a perspective representation of a hose coupling 100 in a side view. The hose coupling 100 comprises a first coupling part 100a and a second coupling part 100b. In the embodiment shown, both coupling parts 100a, 100b are provided with respective hose connection areas 110a, 110b onto which a respective hose piece can be pushed on. The hose coupling 100, for example, is suitable for connection to arbitrary hose pieces, the dimensions of the hose coupling 100 being adapted to the respective hose piece, i.e. when the hose coupling 100 is to be used as a connection between two hose pieces having identical internal diameters and identical external diameters and similar material properties, the respective hose connection areas 110a, 110b will have a substantially identical structural design so that the hose pieces in question can be pushed on and will be mechanically fixed due to their inherent elasticity or will be fixed, if necessary, by additional means, such as hose clamps or the like. In other cases, the hose connection areas 110a, 110b may have different structural designs, when hose pieces having different internal diameters or externally diameters are to be connected by the coupling 100. In other embodiments, one of the connection areas 110a or 110b is configured such that it can be attached to an arbitrary kind of fluid conduit, e.g. a rigid conduit or the like, whereas the other one of the two areas 100a, 100b serves to receive thereon a respective hose piece.

In the embodiment shown, in which both areas 110a, 110b represent connection areas for connection to hose pieces, which, moreover, have similar or identical properties, the areas 110a, 110b can have identical structural designs. In one embodiment, the area 110a or 110b is provided as a tubular connecting piece having an internal diameter which corresponds essentially to the internal diameter of the hose piece to be connected (not shown). In addition, the embodiment shown uses a wall thickness, designated by 111, of approx. 3 mm or less, so that hose pieces having little inherent elasticity can be pushed on, since the external diameter of the connection area 110a, 110b is only slightly larger than the internal diameter of the hose piece to be pushed on, sufficient adhesion being nevertheless accomplished. In the embodiment shown, a tapering end portion 112 is additionally provided, the cone end 112s having thus a substantially smaller wall thickness, so that, on the one hand, there will be a comparatively continuous transition of the respective surfaces from the hose piece to the connection area 110a and, on the other hand, the hose piece can also be pushed on more easily. In one embodiment, both connection areas 110a, 110b or at least one of the connection areas is/are configured such that a milk hose of the type typically used in agricultural enterprises can be pushed on. To this end, the connection areas 110a, 100b are provided with adequate dimensions corresponding to the dimensions of the respective kinds of milk hoses.

The hose coupling 100 is additionally provided with a locking device 120 comprising a first engagement area 120a on the first coupling part 100a and a second engagement area 120b on the second coupling part 100b. In the embodiment shown, the locking device is configured such that the coupling parts 100a, 100b can be locked by means of a rotary movement corresponding to an angle of not more than 90°, without any movable components being required in the locking device 120. For this purpose, the first engagement area 120a of the embodiment shown is provided with at least one cam 121a which is adapted to engage a respective complementary recess 121b provided in the second engagement area 120 and which, when adequately rotated, causes locking of the hose coupling 100, i.e. locking is to be interpreted such that, at least in the axial direction, referred to as 101, both coupling parts 100a, 100b remain mechanically fixed, even if a tensile force should be applied to one or both the coupling parts 100a, 100b in said axial direction 101. Furthermore, the locking device 120 has formed therein suitable sliding surfaces 122a, 122b, which, on the one hand, will have a guiding effect when the parts 100a, 100b are being coupled and which will also provide a certain amount of mechanical stability when locking has taken place, even if only a single cam 121a should be provided in combination with a single recess 121b.

In the case of further illustrative embodiments, two or more cams 121a are provided in combination with the respective complementary recesses 121b, so that a higher mechanical loadability will be achieved in the locked condition. In the embodiment shown, a total number of four cams 121a is provided, said cams being arranged around the engagement area 120 at an angular distance of approx. 90°. In other embodiments, there may be provided two, three or more than four cams 121a whose distribution over the engagement area 120a can be chosen in a suitable manner. It is, for example, not necessary that the respective cams 121a are positioned in the same plane, as shown e.g. in FIG. 1a, but they may also be displaced in the axial direction 101. In this case, corresponding measures will have to be taken in the complementary recesses 121b, so that correspondingly longer sliding paths will be formed in the axial direction for cams 121a facing the complementary area 120b more closely. It follows that the provision of said one or said plurality of cams 121a allows, in combination with the respective complementary recesses 121b, a mechanical fixing of the coupling parts 100a, 100b without any additional movable components being necessary.

Furthermore, the hose coupling 100 comprises a sealing 100c, which is attached to one or both coupling parts 100a, 100b and which, in the embodiment shown, is provided in the form of an O-ring. In the embodiment variant shown, the O-ring 100c is attached to the first coupling part 100a, so that the O-ring 100c is accessible in the non-connected condition, whereas, in the connected condition, said O-ring 100c is well protected by the sliding surfaces 122b of the area 120b, so that external influences will have little effect and, in particular, there will not be much contamination.

FIG. 1b shows, in a schematic perspective side view, the hose coupling 100 when the latter has been connected along the longitudinal axis 101, i.e. the engagement areas 120a, 120b engage one another by means of said one or said plurality of cams 121a and the respective complementary recesses 121b. Locking has here not yet taken place, at least not with respect to a tensile force in the direction of the longitudinal axis 101. In the embodiment shown, an area 123b, which serves to guide said one or said plurality of cams 121a, is provided for locking the coupling 100, the length of said area 123b adjusting, in the final analysis, also the force acting on the sealing ring 100c (cf. FIG. 1a), as will be explained in more detail with respect to FIG. 1d. Furthermore, a locking area 124b is provided, along which said one or said plurality of cams 121a is guided during a rotary movement and in which said cams 121a will finally be positioned in the locked condition. In addition, a projection 127b is provided at the transition between the areas 123b and 124b, said projection guaranteeing a certain stability of the position of the cam(s) 121a in the locked condition.

FIG. 1c shows a schematic representation of the hose coupling 100 in the locked condition. It can be seen that, other than in the condition of the hose coupling 100 shown in FIG. 1b, the two coupling parts 100a, 100b are displaced relative to one another by a certain angle, which is smaller than 90° in the embodiment shown, so that each of the cams 121a is in engagement with the locking area 124b which extends at an angle relative to the area 123b and which provides, at least as far as tensile forces along the longitudinal axis 101 (cf. FIG. 1b) are concerned, an efficient and reliable mechanical coupling of the parts 100a, 100b. The length 125b of the locking area 124b thus determines the rotary angle for rotating the coupling parts 100a, 100b relative to one another, which is required for locking. In the embodiment shown, this requires e.g. a rotation within the range of less than 30°, so that the coupling 100 can also be locked, without excessive effort, if one hose piece or both hose pieces, which are attached to one of the parts 100a, 100b or to both said parts, should have comparatively little elasticity, at least with respect to twisting. When the parts 100a, 100b are being joined, also the sealing 100c will undergo a minor elastic deformation, the thus caused “resetting” force pressing, in the locked condition, the cam(s) 121a in the area 124b against the wall adjoining the projection 127b, so that said projection 127b will, in combination with the resetting force, counteract a rotary displacement of the parts 100a, 100b and stabilize the locking position in this way.

In some embodiments (not shown) the recesses 121b, i.e. the areas 123b and the locking area 124b, may be configured such that, when the coupling parts 100a, 100b are being joined, a certain degree of twisting of the coupling parts will initially be caused due to the fact that the area 123b acting as a guide means extends at a suitable oblique angle, so that the respective connected hose piece will be under a certain degree of “pretension”, which will then also have the effect that the respective cam 121a will be pushed into the locking area 124b by means of said pretension thus providing a certain stability as regards an unintentional twisting of the coupling parts 100a, 100b on the basis of the counterforce caused by the elasticity of the connected hose piece. It follows that a certain “self-locking” effect of the type shown in FIG. 1c is achieved in the locked condition. Also the elasticity of the O-ring 100c can contribute to this effect. As has been described hereinbefore, also this O-ring 100c can, provided that the areas 123b, 124b have a suitable configuration, generate a certain degree of resetting force, when an unintentional rotational load acts on the hose coupling 100.

FIG. 1d shows a schematic sectional view of the hose coupling 100 in the locked condition. As shown, the cams 121a are in engagement with the respective recesses 121b and, in particular, with the locking areas 124b (cf. FIG. 1c), which are not shown in FIG. 1d, so that the two parts 100a, 100b are connected in a mechanically stable manner. In addition, the sealing ring 100c prevents an ingress of undesirable substances into the interior of the hose coupling 100 and it also prevents an escape of substances from said interior, this having in particular also the effect that gas tightness is achieved, so that the coupling 100 can also be used advantageously for conducting gases, in particular under vacuum conditions in the interior of the coupling 100. As can additionally be seen from the embodiment shown, the coupling part 100b comprises a conically configured area 126b following the sliding surfaces 122b. The area 126b also defines a conical sealing surface 126s, which is in contact with the sealing ring 100c. Due to the angle which the sealing surface 126s defines with the longitudinal direction 101 (cf. FIG. 1a, 1b), a “gearing” of, i.e. an increase in the contact pressure force acting on the sealing ring 100c takes place during coupling of the parts 100a, 100b, so that a reliable tightness can be accomplished. It follows that, by means of this conical sealing surface, it will also be possible to compensate a certain out-of-roundness of the O-ring 100c and/or of the area 126b. Furthermore, the conical surface 126s also causes an elastic deformation of the sealing ring 100c along the longitudinal axis, which leads to a desired resetting force during locking and thus, in cooperation with the projection 127b (cf. FIG. 1b, 1c), to a stable locked condition, as has also been explained hereinbefore.

As has already been described, the necessity of separating respective fluid conduits often occurs, especially when said conduits are used in connection with automatic milking plants, it being then necessary to transmit the milk as well as the necessary operating pressure in the conduits in question. As is additionally shown, the coupling parts 100a, 100b define a suitable transition area 130 in which the fluid-conducting internal spaces of the two parts 100a, 100b join one another. In the embodiment shown, said internal spaces are chosen such that they are identical so that also in the area 130 a surface 130s will be formed, which allows a flow without turbulences that would be worth mentioning being caused in the transition area 130, i.e. the surface 130s has neither any major elevations nor depressions that could interfere with the flow. In the embodiment shown, the respective end faces 130a and 130b are arranged such that they extend at a very small distance from one another, so as to allow e.g. for possibly existing manufacturing tolerances, so that only a small gap is formed in the surface 130s, i.e. when the hose coupling 100 is in operation, a comparatively undisturbed flow of the operating fluid, e.g. the milk, can be achieved, and also the desired pressure conditions in the respective fluid conduit are maintained by the coupling 100 in view of the high tightness and the high reliability of the sealing 100c in cooperation with the conical sealing surface 126s.

Furthermore, a major deposition of residues, which might result in hygienic problems, does not even occur in connection with critical liquids and/or gases, e.g. in the food processing industry, e.g. in the form of milk. In particular, also typical critical areas, such as the area 130, can be acted upon by a cleaning liquid, without necessitating any additional effort for the cleaning process. This means that the rinsing of the fluid conduit, which is typically carried out at regular intervals in agricultural enterprises, will also suffice for cleaning the hose coupling 100, since the structural design of the hose coupling 100 avoids the formation of critical areas and since substantially no components having a distinctive surface topography will come into contact with the fluid.

It follows that a hose coupling 100 of the type described e.g. with reference to FIG. 1a to 1d can be produced in an efficient manner, e.g. in the form of injection moulded parts, whereby the necessary dimensional accuracy of the respective components, e.g. the cams 121a and the recesses 121b, will be guaranteed by design measures without any special finishing treatments being required. This means that, in the embodiments shown, the final completion of the hose coupling 100 only necessitates that a further component, i.e. the sealing 100c, is attached to one of the coupling parts. For this purpose, the usual O-ring sizes can be used, and an adaptation to standard sizes will be possible by means of design measures with respect to the coupling parts 100a, 100b. It is thus possible to obtain a reliably and precisely effective connection of milk lines, the small number of individual components in combination with their precise reproducibility resulting in small tolerances and, consequently, in the desired reliability combined with easy handling. In addition, the external areas of the coupling parts 100a, 100b can be cleaned efficiently and easily, since sensitive components, such as springs, coupling nuts and the like, do not exist. Provided that suitable materials are used, the hose coupling 100 can be used for critical substances, e.g. food, in the form of milk, etc.; in particular polyamide materials, e.g. type 6 or 12, can efficiently be used, said materials allowing also an efficient production making use of injection moulding processes.

The compact structural design of the hose coupling 100 also allows disassembly in the case of a high degree of contamination, which may frequently occur especially in the agricultural sector, without any risk of impairing the function of components, since the compact external surfaces, which do not comprise any delicate components, are easy to clean and since the small number of individual components can, if contaminated, also easily be cleaned during disassembly. This is achieved by the compact structural design, which avoids small, sensitive or complex components having the form of e.g. springs, nuts, movable pins, etc.

1. (canceled)

2. A hose coupling according to claim 16, wherein the complementary areas (120a, 120b) are dimensionally stable when they are being locked.

3. A hose coupling according to claim 16, wherein the first coupling part comprises a first area (120a) of the two complementary areas, said first area (120A) comprising one or a plurality of cams (121a).

4. A hose coupling according to claim 3, wherein the second coupling part comprises a second area (120b) of the two complementary areas, said second area (120b) comprising one or a plurality of recesses (121b) for engagement with said one or said plurality of cams (121a).

5. A hose coupling according to claim 16, wherein said first and said second coupling part are composed of a polyamide material.

6. A hose coupling according to claim 5, wherein said first and said second coupling part are fully composed of the polyamide material.

7. A hose coupling according to claim 4, wherein there are provided precisely four cams (121a) and locking recesses (121b) which are complementary to said four cams (121a).

8. A hose coupling according to claim 16, wherein the sealing ring is provided on the first coupling part (100a).

9. A hose coupling according to claim 16, wherein the first and the second coupling part are each provided with a hose connection area (100a, 110b), which is implemented as a thin tube and which has a wall thickness of 3 mm or less.

10. A hose coupling according to claim 16, wherein the first and the second coupling part are each provided with a transition area (130), said transition areas defining together a fluid path when the first and the second coupling part are locked, and wherein the fluid path defines a surface (130s) which does not cause major turbulences.

11. A hose coupling according to claim 10, wherein the transition areas defining the fluid path have neither any elevations on nor any depressions in their surfaces.

12. A hose coupling according to claim 6, wherein the polyamide material comprises polyamide 6 and/or polyamide 12.

13. A hose coupling according to claim 16, wherein the first and the second coupling part are, with the exception of the sealing ring, fully produced from a uniform material.

14. A hose coupling according to claim 16, wherein an angular range required for locking is 90° or smaller.

15. A hose coupling according to claim 14, wherein the angular range required for locking is 30° or smaller.

16. A hose coupling for connection to a hose piece suitable for conveying food, comprising
a first coupling part (100a),
a second coupling part (100b) provided with a conically configured outer area (126b) which defines a conical sealing surface (126s),
an O-ring (100c) attached to said first (100a) or said second coupling part (100b),
wherein said first coupling part (100a) and said second coupling part (100b) comprise areas (120a, 120b) which are configured such that they are complementary to one another and which do not include any movable components, and said first and second coupling parts (100a, 100b) are adapted to be locked on one another by means of said complementary areas, so that the O-ring (100c) is in contact with the conical sealing surface (126s), and wherein the first coupling part (100a), the second coupling part (100b) and the O-ring ring (100c) are the only components.
